(19) United States
(12) Patent Application Publication
(10) Pub. No.: US 2026/0285504 A1
(43) Pub. Date: Sep. 24, 2026

(54) AUTOMATED HANDLING OF MINIMUM EQUIPMENT LIST FAILURES

(71) Applicant: Honeywell International Inc., Charlotte, NC (US)

(72) Inventors: Kalimulla Khan, Bangalore (IN); Kantha Chikkegowda, Bangalore (IN); Subhransu Sahoo, Bengaluru (IN); Srilakshmi Kurudi, Bangalore (IN)

(21) Appl. No.: 19/235,364

(22) Filed: Jun. 11, 2025

(30) Foreign Application Priority Data
Mar. 19, 2025 (IN) 202511024526

(51) Int. Cl. B64F 5/60

(52) U.S. Cl. CPC B64F 5/60

(57) ABSTRACT

An example method for generating MEL resolution recommendation includes: obtaining input data from a computing system of an aircraft, wherein the input data includes at least MEL failure information identifying an MEL failure for the aircraft; determining a plurality of MEL resolution candidates; simulating performance of the aircraft with the MEL failure for the plurality of MEL resolution candidates to generate simulation results for the aircraft; analyzing the simulation results, using a predefined policy, to select an MEL resolution candidate from the plurality of MEL resolution candidates; generating an indication of an MEL resolution recommendation based on the selected MEL resolution candidate; and transmitting the indication of the MEL resolution recommendation to the computing system of the aircraft.

This application claims the benefit of Indian Provisional Patent Application No. 202511024526, filed Mar. 19, 2025, the entire contents of which is incorporated herein by reference.

### TECHNICAL FIELD

The techniques of this disclosure relate to aircraft operations safety.

### BACKGROUND

A Minimum Equipment List (MEL) is an important document and process in aviation that allows aircraft to operate safely with certain equipment inoperative. The MEL acknowledges that not all equipment failures necessitate grounding an aircraft. The MEL provides a framework for determining which equipment may be inoperative while maintaining an acceptable level of safety.

### SUMMARY

Use of a Minimum Equipment List (MEL) may better ensure that aircraft operations remain compliant with Federal Aviation Regulations (FAR) while allowing for the aircraft to still fly with minor equipment issues that do not threaten safety. By allowing flights to proceed with certain inoperative equipment, the MEL may minimize delays and disruptions, improving operational efficiency. The MEL may be tailored to each specific aircraft, considering the unique configuration and installed equipment of the specific aircraft. The MEL may list the specific pieces of equipment that may be inoperative under certain conditions and outline the specific conditions under which an aircraft can operate with inoperative equipment, including any limitations or procedures. Before each flight, the aircraft may be thoroughly evaluated for any faulty equipment listed in the MEL, and the MEL may be consulted to determine if the aircraft remains airworthy with the inoperative equipment. If the MEL allows for operation with the faulty equipment, specific maintenance procedures may be required. A Master Minimum Equipment List (MMEL) is a list created by the aircraft manufacturer, approved by the aviation authority, and may serve as a basis for the MEL of the operator. The MEL may be a customized list developed by the operator, based on the MMEL, and approved by a local aviation authority. The MEL may be generated taking into account the specific aircraft of the operator, operations, and regulatory requirements.

Faults may be discovered in various ways, such as during flight by the crew, during pre-flight pilot inspections, or during scheduled routine maintenance. Faults may be reported by any crew member interacting with the aircraft (e.g., cabin crew, ground crew). The MEL is an important document consulted whenever a piece of equipment is found to be faulty. Quickly determining resolutions to equipment failures is critical to keeping flights on schedule. For example, for many shorter domestic flights, an aircraft may be scheduled to be on the ground for less than an hour between flights, thus not allowing for much time to resolve equipment failures without causing delays.

The disclosure describes techniques that automate how aircraft operators deal with equipment failures during the dispatch process, making the process faster, more efficient, and safer. For example, the disclosed system may provide an MEL engine that automatically analyzes equipment failures and determines a best course of action based on the MEL. The disclosed techniques may provide interfaces for key personnel. These techniques may provide an interface to report faults to pilots and to receive information about the status of the aircraft.

In one non-limiting example, the disclosed interface may help dispatchers to manage the dispatch process, taking into account equipment failures and MEL requirements. The disclosed system may oversee the overall operation and maintenance of the aircraft. The MEL engine may receive real-time data from the avionics systems of the aircraft, allowing the MEL engine to detect equipment failures as the failures occur. In some examples, the MEL engine may analyze the failure, may consult the MEL, and may determine an optimal solution, considering various factors, such as, but not limited to cost, time and safety.

According to an example of the present disclosure, a computer-implemented method for generating MEL resolution recommendation includes: obtaining input data from a computing system of an aircraft, wherein the input data includes at least MEL failure information identifying an MEL failure for the aircraft; determining a plurality of MEL resolution candidates; simulating performance of the aircraft with the MEL failure for the plurality of MEL resolution candidates to generate simulation results for the aircraft; analyzing the simulation results, using a predefined policy, to select an MEL resolution candidate from the plurality of MEL resolution candidates; generating an indication of an MEL resolution recommendation based on the selected MEL resolution candidate; and transmitting the indication of the MEL resolution recommendation to the computing system of the aircraft.

According to another example of the present disclosure, a system for generating a Minimum Equipment List (MEL) resolution recommendation includes: a memory; and processing circuitry coupled to the memory and configured to: obtain input data from a computing system of an aircraft, wherein the input data includes at least MEL failure information identifying an MEL failure for the aircraft; determine a plurality of MEL resolution candidates; simulate performance of the aircraft with the MEL failure for the plurality of MEL resolution candidates to generate simulation results for the aircraft; analyze the simulation results, using a predefined policy, to select an MEL resolution candidate from the plurality of MEL resolution candidates; generate an indication of an MEL resolution recommendation based on the selected MEL resolution candidate; and transmit the indication of the MEL resolution recommendation to the computing system of the aircraft.

According to yet another example of the present disclosure, non-transitory computer-readable storage media having instructions encoded thereon, the instructions configured to cause processing circuitry to: obtain input data from a computing system of an aircraft, wherein the input data includes at least MEL failure information identifying an MEL failure for the aircraft; determine a plurality of MEL resolution candidates; simulate performance of the aircraft with the MEL failure for the plurality of MEL resolution candidates to generate simulation results for the aircraft; analyze the simulation results, using a predefined policy, to select an MEL resolution candidate from the plurality of MEL resolution candidates; generate an indication of an MEL resolution recommendation based on the selected MEL resolution candidate; and transmit the indication of the MEL resolution recommendation to the computing system of the aircraft.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a simplified illustration of an aircraft coupled to a MEL resolution recommendation system in accordance with the techniques of this disclosure.

FIG. 2 illustrates an example of MEL resolution recommendation system in accordance with the techniques of this disclosure.

FIG. 3 illustrates an example of MEL engine in accordance with the techniques of this disclosure.

FIG. 4 illustrates an example of an avionics system in accordance with the techniques of this disclosure.

FIG. 5 depicts a flowchart illustrating a method for generating MEL resolution recommendation in accordance with the techniques of the present disclosure.

### DETAILED DESCRIPTION

Typically, the MEL is a legally approved document, specific to an aircraft type (e.g., Boeing 737-800, Airbus A320), that may allow an aircraft to be dispatched even with certain equipment inoperative. The MEL may be an important part of operations of an airline, balancing safety with the practicalities of maintenance and scheduling. Aircraft may have redundant systems. A backup system may exist for something non-essential for flight safety. The MEL may acknowledge this. Waiting for a minor part to be shipped could cause significant delays and cancellations, impacting passengers and airline efficiency. The MEL may allow for continued operation in some cases while repairs are scheduled. The MEL may provide a structured way to manage inoperative equipment while maintaining safety. Typically, the MEL needs to be approved by the Federal Aviation Administration (FAA) (or the equivalent regulatory authority in other countries). This ensures safety standards are met.

Master Minimum Equipment List (MMEL) is a list created by the aircraft manufacturer and approved by the FAA. The MMEL may serve as the basis for individual airline MELs. Airlines may make their MELs more restrictive than the MMEL but not less restrictive.

While based on the MMEL, the MEL of each airline may be tailored to specific aircraft configurations, operational procedures, and maintenance practices of the airline. The MEL typically does not just say “this item can be inoperative.” The MEL may detail how the aircraft may be operated with the inoperative equipment. These details may include, but are not limited to procedures, limitations and time limits. The procedures may include specific actions the pilots or maintenance personnel should take. The limitations may include restrictions on the operation of the aircraft (e.g., no extended overwater flights, reduced passenger capacity).

Time limits may specify how long the aircraft may fly with the inoperative equipment before the inoperative equipment should be repaired. These time limits may be important for maintaining safety. The dispatch process may be important as well. Before a flight, the maintenance status of the aircraft may be checked against the MEL. If there is inoperative equipment, the dispatch team may use the MEL to determine if the flight may proceed safely and legally. If the inoperative equipment is not covered by the MEL, or if the conditions of the MEL cannot be met, the aircraft may be considered non-airworthy and may not fly.

The term “dispositioning,” as used herein, refers to the process of deciding what to do about faulty equipment. This decision should be based on the recommendations outlined in the aircraft's MEL. The MEL may be the ultimate authority on whether a flight may proceed with a particular piece of equipment inoperative, and if so, under what conditions. Faults may be identified in various ways. Pilots may notice a system malfunction during flight. Pilots may perform pre-flight checks, which may reveal inoperative or faulty equipment. During scheduled maintenance, technicians may discover issues.

Cabin crew, ground crew, or other personnel may report problems they observe. The MEL, in conjunction with standard maintenance procedures, may dictate the acceptable resolutions for inoperative equipment. The faulty equipment may be fixed. This is the most common and preferred solution. The faulty equipment may be replaced with a functional spare part. This is often quicker than repair, minimizing downtime. Many aircraft have redundant systems. The MEL may allow the flight to proceed if the backup system is operational. The MEL may specify if the redundant system needs to be checked or activated.

In some cases, the flight plan or mission may be modified to avoid the need for the faulty equipment. For example, if a weather radar is inoperative, the flight may avoid areas of known severe weather. This may be the only option if there is no repair or redundancy available. The MEL may allow the aircraft to fly with the equipment inoperative for a specified period, subject to certain conditions and limitations. This deferral may allow time for repairs to be made without causing immediate flight delays or cancellations. This may be one of the main functions of the MEL. The MEL may need to be followed precisely. The MEL is a legally approved document, and deviations may have serious consequences. Flying with inoperative equipment that is not covered by the MEL, or not adhering to the MEL's conditions and limitations, may compromise safety. Furthermore, ignoring the MEL may lead to fines and other penalties from aviation authorities.

Each option for resolving inoperative equipment may have associated costs and time implications. For example, repair may be costly, especially if specialized parts or technicians are required. Repair may also take time, potentially leading to delays or cancellations. Replacing a part may be faster than repair, but replacement may still incur the cost of the new part. If the part is not readily available, replacements may also lead to delays. While seemingly simple, activating a redundant system may require checks and procedures that take time.

The redundant system activation option also assumes the redundant system is functioning correctly. If the redundant system also has a fault, the situation may become much more complex. Changing a flight plan may be costly, especially if the change involves rerouting, additional fuel, or changes in crew scheduling. Changing a flight plan may also inconvenience passengers. While deferral may allow the flight to proceed, the deferral may not eliminate the problem. The repair may still need to be done eventually, and the clock may be ticking. There may also be a risk that the deferred item may become worse, potentially grounding the aircraft later. Any resolution, even if allowed by the MEL, should be assessed against other factors to ensure flight safety.

In some examples, some MEL items may be acceptable in good weather but not in bad weather. Overwater flights or flights to remote locations may have stricter requirements for certain equipment. The cumulative effect of multiple inoperative items should be considered. Even if each item is individually covered by the MEL, the combined effect may create an unsafe situation. In some cases, specific pilot qualifications or experience may be required to operate the aircraft with certain inoperative equipment. The timing of these decisions (often just before pushback) may lead to suboptimal solutions. Dispatchers may be under pressure to get the flight out on time, and the dispatchers may choose a quick fix that may not be the most cost-effective or efficient in the long run.

As noted above, a quick fix may result in increased costs, operational inefficiencies, and compromised safety. In some examples, a rushed repair may be more expensive than a planned repair. A deferred item may lead to a more significant disruption later. While the MEL may ensure a minimum level of safety, a rushed decision may overlook subtle risks. Several strategies may help mitigate these issues.

Proactive maintenance may reduce the likelihood of equipment failures. Having readily available spare parts may speed up repairs.

As a non-limiting example, an aircraft A may have a faulty component covered by the MEL, and Aircraft B may be on the ground for scheduled maintenance. Instead of waiting for a new part, the airline could potentially take the needed part from Aircraft B to get Aircraft A back in the air quickly. This resolution may get aircraft A flying, potentially avoiding a cancellation or significant delay. However, now aircraft B may be potentially grounded until the part is replaced. This may impact a future flight, but the immediate pressure is on aircraft A. Also, there may be logistical considerations (paperwork, tracking the part, etc.).

Over time, the aforementioned seemingly simple solution may have ripple effects. A good decision in the short term may create a bigger problem later. This highlights the need for a system that can see the bigger picture. A quick fix may have unintended consequences. For example, changing one component may affect the performance of another system in ways that are not immediately obvious. Thorough testing and analysis may be important.

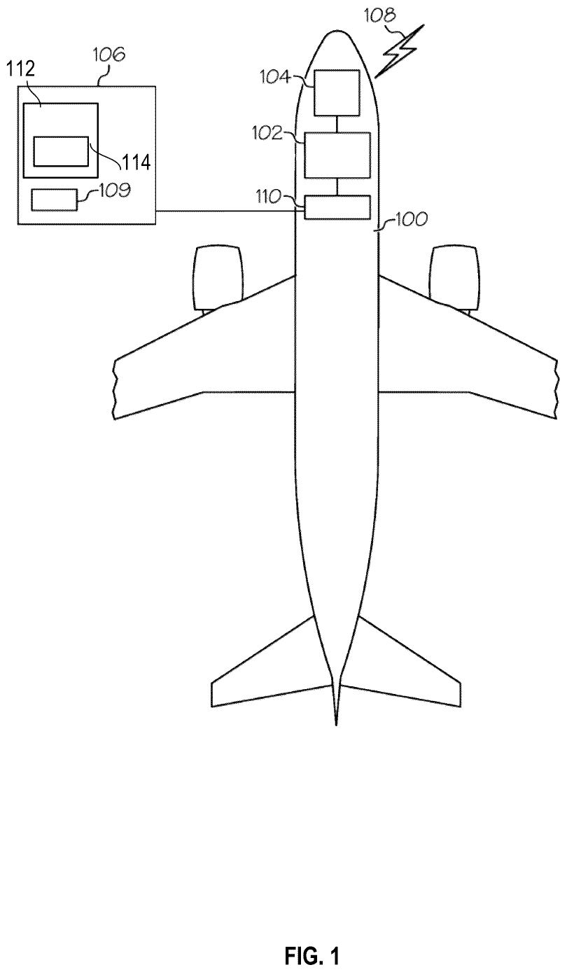

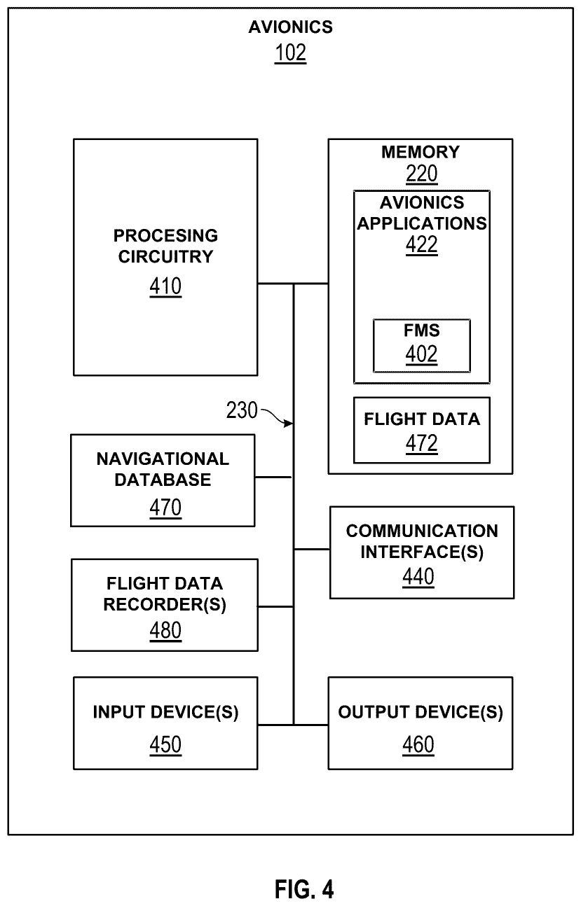

FIG. 1 is a simplified illustration of an aircraft coupled to a MEL resolution recommendation system in accordance with the techniques of this disclosure. Avionics system 102 may be coupled to one or more output modules 104. Avionics system 102 is described in greater detail below in conjunction with FIG. 4. The aircraft 100, and its subsystems and modules may also receive wireless communications 108 from, for example, aircraft communications addressing and reporting system (ACARS), satellite, and similar means of wireless communications.

Aircraft 100 may include a user interface 110 coupled to the avionics system 102. Ground station 106 may also include a user interface 109 communicatively coupled to avionics system 102 and user interface 110. MEL resolution recommendation system 112 may be coupled to the user interface 109. The MEL resolution recommendation system 112 may be configured to process various input parameters to generate one or more MEL resolution recommendations. In an aspect, MEL resolution recommendation system 112 may include one or more component, such as, but not limited to MEL engine 114. The user interfaces 109 and 110 may include but are not limited to any combination of one or more of the following: a keypad, touchpad, keyboard, mouse, touchscreen, joystick, knob, microphone, speech or gesture recognition or another suitable device adapted to receive input from a user. Input data, such as, for example, aircraft state parameters, may be entered via user interface 110 onboard the aircraft 100.

In some examples, one or more output modules 104 may include a display module. In some examples, the display module may selectively render various intuitive textual, graphic, iconic data, two dimensional or three dimensional, still or moving image data, and thereby may supply additional visual feedback and alerts to the pilot. It will be appreciated that the display module may be implemented using any one of numerous known display devices suitable for rendering textual, graphic, and/or iconic information in a format viewable by the pilot. Non-limiting examples of such display devices may include various multifunction displays (MFD), Near to Eye (NTE), projection displays, cathode ray tube (CRT) displays, and flat screen displays such as LCD (liquid crystal display) and TFT (thin film transistor) displays. The display module may additionally be implemented as a screen mounted display, or any one of numerous known technologies. It is additionally noted that the display module may be configured as any one of numerous types of aircraft flight deck displays. For example, the display module may be configured as a multi-function display, a horizontal situation indicator, a vertical situation indicator, or the like. In some examples, however, at least one display module may be configured as PFD.

Operating aircraft 100 with degraded systems may require pilots to follow different procedures. If these procedures are complex or not well-understood, the risk of errors may increase. In addition, flying with inoperative equipment may increase the pilot's workload, especially if pilots have to manage multiple degraded systems. This increased workload may lead to fatigue and reduced situational awareness. In addition, there is a gap in the industry when it comes to tools and systems that may effectively guide MEL-related decisions. While MELs themselves are well-defined, the process of choosing the best resolution in real-time is often ad-hoc and relies on the experience and judgment of dispatchers and maintenance personnel. This process may lead to inconsistencies and suboptimal outcomes. The number of possible combinations of inoperative equipment, aircraft types, flight schedules, maintenance schedules, spare parts availability, and other factors may be enormous. It is additionally noted that decisions often have to be made quickly, under pressure. For example, having access to all the necessary information (aircraft status, parts inventory, maintenance schedules, etc.) in a timely manner may be challenging. In some examples, the impact of a particular decision may not be fully predictable.

In one example, MEL resolution recommendation system 112 may provide modules that can analyze the various factors involved in an MEL decision and may suggest optimal solutions based on, for example, cost, time, and safety considerations. As noted above, the disclosed MEL resolution recommendation system 112 may connect different systems (maintenance, dispatch, parts inventory) to provide a holistic view of the situation. The MEL resolution recommendation system 112 may also use simulations to evaluate the potential impact of different MEL resolution candidates.

In some examples, MEL engine 114 may provide a holistic assessment. In other words, MEL engine 114 may consider all relevant factors when making an MEL-related recommendation, not just the immediate issue. In some examples, safety of flight operations may be very important.

In some examples, MEL engine 114 may consider at least some of the following factors. How does the equipment failure affect the ability of the aircraft to safely perform intended mission? Are there redundancies? What are the limitations? How does the failed equipment interact with other aircraft systems? What are the potential cascading effects of a workaround or temporary fix?

What tools, personnel, and expertise are available to address the issue? Is there pressure to get the aircraft back in service quickly? How does this pressure influence the decision-making process? What level of risk is acceptable given the specific circumstances?

Airlines may constantly juggle competing priorities. An Aircraft On Ground (AOG) situation may be costly. A grounded aircraft 100 may generate no revenue and may disrupt schedules, leading to further expenses like passenger compensation and rebooking. In some examples, canceled or delayed flights may inconvenience passengers, leading to dissatisfaction, potential refunds, and damage to the reputation of the airline. Revenue impact may encompass both the direct loss of revenue from a grounded aircraft 100 and the potential long-term impact of passenger dissatisfaction and reputational damage. If a particular piece of equipment fails frequently across the fleet, such failures may indicate a systemic issue requiring a broader solution (e.g., a design flaw, a need for updated maintenance procedures, or a change in suppliers). Airlines may need to strategically manage the inventory of spare parts.

If a critical part is in short supply, the part may lead to prolonged AOG situations. Decisions about which parts to stock and where to store the parts may be important. Maintenance may need to be scheduled efficiently to minimize disruptions.

Airlines may try to coordinate maintenance with periods of lower demand and may try to perform routine checks during overnight layovers. Grounding an aircraft may also affect crew scheduling.

Airlines may need to better ensure that the airlines have enough qualified personnel to operate all of the flights. High-revenue routes or fully booked flights may take precedence. Airlines may prioritize getting those aircraft back in the air as quickly as possible, even if such decision means delaying maintenance on other aircraft. Different aircraft types may have different operational characteristics and may be used on different routes. Airlines may need to consider these factors when making maintenance decisions.

The concept of MEL may provide guidance to MEL resolution recommendation system 112 on which equipment may be inoperative while still allowing the aircraft 100 to fly. Airlines may need to carefully assess the impact of MEL items on safety and operations, as well as costs. Direct costs may include, but are not limited to, the cost of repairs, spare parts, labor, and any compensation paid to passengers.

In other words, AOG situations may be urgent. Every minute an aircraft is grounded may translate to lost revenue for the airline and potential inconvenience for passengers. This urgency may be amplified when passengers are directly affected, such as being stranded at an airport or missing connecting flights. Airlines may prioritize minimizing the aforementioned disruptions. Airlines may strive to get the aircraft 100 back in service as quickly as possible, may rebook passengers on alternative flights, may provide accommodations if necessary, and may offer compensation for the inconvenience. However, despite the best efforts, AOG incidents may still lead to significant passenger disruptions.

MELs are currently managed manually by a collaborative effort, which may involve but is not limited to dispatch personnel, maintenance crews, and pilots. The current process may involve recognizing the equipment failure and consulting the MEL to determine if aircraft 100 is airworthy with the inoperative equipment.

The team should decide whether to defer the maintenance and fly with the MEL item or ground the aircraft 100 for immediate repair. This decision may involve weighing the safety implications, operational impact, and available resources. Effective communication between dispatch, maintenance, and pilots may be important to ensure everyone is on the same page and the decision is implemented correctly.

Manual MEL management process may have limitations. Manually reviewing MEL documents and coordinating between different teams may be time-consuming, especially in urgent AOG situations. Manual processes may be prone to human error. Misinterpretation of MEL requirements or miscommunication between teams may lead to incorrect decisions with safety implications. Manual processes may not provide real-time visibility into the status of aircraft systems or the availability of spare parts and maintenance personnel. Lack of real-time data may hinder efficient decision-making.

Challenges associated with manual MEL management highlight the need for more efficient and automated solutions. The aforementioned MEL resolution recommendation system 112 may move paper-based MEL documents to digital formats that are easily accessible and searchable. MEL resolution recommendation system 112 may integrate MEL information with other systems, such as, but not limited to maintenance tracking, flight scheduling, and spare parts inventory, to provide a holistic view of the situation. MEL resolution recommendation system 112 may help the team quickly assess the impact of MEL items and may identify the most appropriate course of action.

Currently, as discussed before, MEL management relies heavily on manual processes and coordination between different teams. Current process is inefficient, prone to errors, and may lead to suboptimal decisions, especially during AOG situations.

In some examples, MEL resolution recommendation system 112 may analyze MEL items across the entire fleet to identify potential solutions and optimize the recommended response. MEL resolution recommendation system 112 may be configured to quickly determine which locations/aircraft have the needed spare parts available. This could include checking inventory at various maintenance bases or even checking other aircraft. In an aspect, MEL resolution recommendation system 112 may identify approved alternate parts that may be used if the primary part is unavailable.

This search for alternate parts may require access to parts databases and technical documentation. MEL engine 114 may analyze historical data to identify trends and patterns related to MEL items. This could help predict future failures and optimize maintenance schedules. MEL engine 114 may also estimate the impact of different MEL resolutions on operations, including, but not limited to, potential delays, cancellations, and revenue loss. In an aspect, one of the components of MEL engine 114 (a digital twin) may allow airlines to simulate the impact of MEL recommendations before the recommendations are implemented in the real world. The digital twin module may accurately model the systems of the aircraft 100 and the interdependencies between these systems. Users may input a specific MEL failure information identifying an MEL failure for the aircraft (e.g., “Inoperative #2 hydraulic pump”) via interface 110, for example. The MEL engine 114 may simulate the impact of this inoperative equipment on other systems and the overall performance of the aircraft 100. Users may then test different MEL resolutions (e.g., deferring the repair, using an alternate part) within the MEL engine 114 to see how these resolutions would affect safety, operations, and maintenance.

In an aspect MEL engine 114 may enable airlines to make more informed decisions about MEL management, minimizing risks and maximizing efficiency. By providing better insights into the impact of MEL items, the disclosed techniques may help prevent safety-compromising decisions. Faster identification of solutions and optimized maintenance schedules may minimize aircraft downtime.

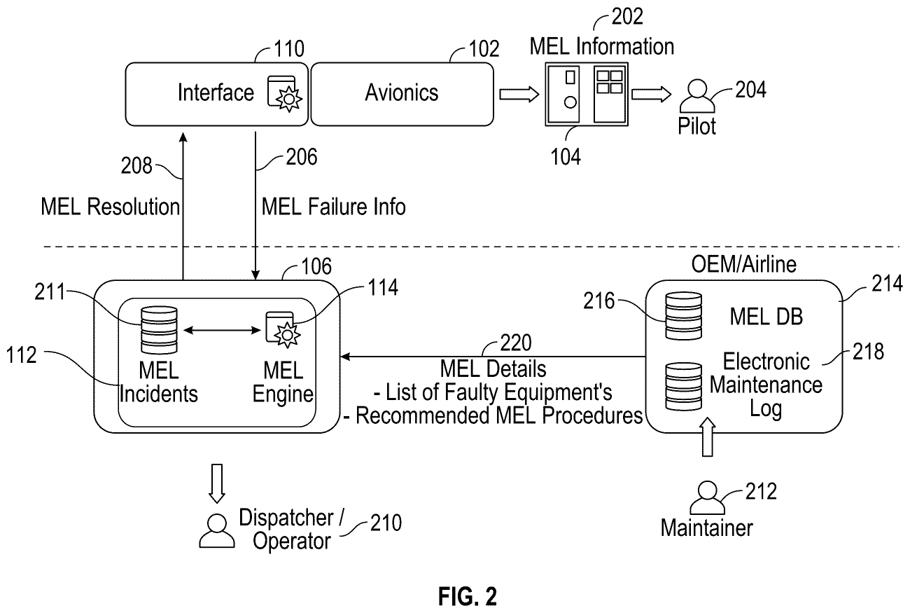

FIG. 2 illustrates an example of MEL resolution recommendation system in accordance with the techniques of this disclosure. As noted above, reduced AOG time may translate to cost savings in terms of lost revenue and passenger compensation. Streamlined MEL management processes may free up maintenance personnel to focus on other tasks.

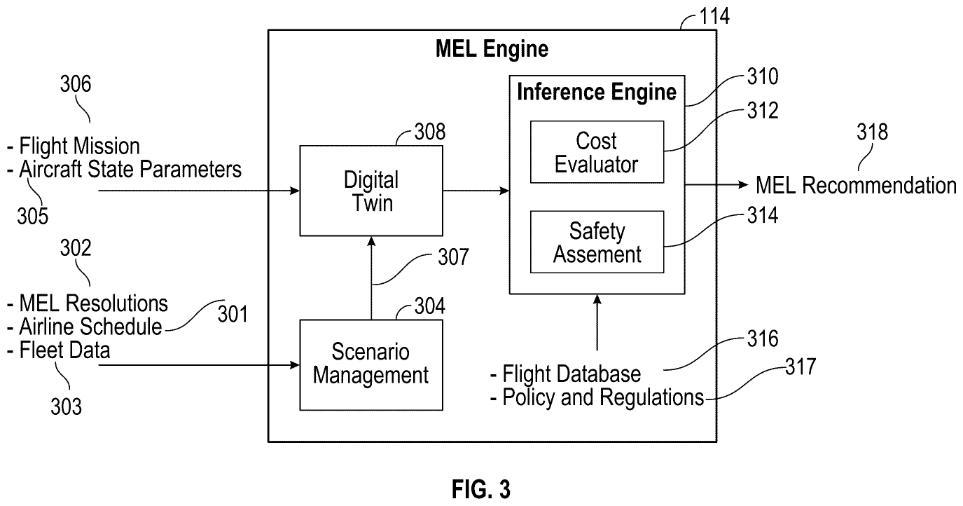

In an aspect, inference engine 310 shown in FIG. 3 may be one of the key components of MEL engine 114. The inference engine 310 may take input data (in this case, information about the aircraft, the MEL item (e.g., MEL failure info 206), available resources, etc.) and may apply rules and logic to draw conclusions and make recommendations. In the context of MEL management, MEL engine 114 may process information from various sources, including the MEL document itself, previously reported MEL incidents 211, aircraft systems data, maintenance logs 218, spare parts inventory, crew availability, and even weather forecasts. At least some of the aforementioned data may be stored in MEL database (DB) 216. In an aspect, inference engine 310 of MEL engine 114 may utilize a set of pre-defined rules (based on regulations, best practices, and manufacturer recommendations) to evaluate the situation. In an aspect, MEL engine 114 may generate specific, actionable recommendations for resolving the MEL item, which may be passed back to avionics system 102 via interface 119 as MEL resolutions 208. The MEL resolution 208 may include recommendations deferring the repair (if allowed by the MEL) and specifying any operational restrictions. MEL resolution 208 may also include identifying the optimal spare part and the location of the spare part. MEL resolution 208, which is a MEL resolution candidate, may suggest alternative maintenance procedures. The MEL engine 114 may also recommend a course of action to minimize passenger disruptions. The MEL engine 114 may rank the recommendations (e.g., MEL resolutions 208) based on factors such as, but not limited to, safety, cost, operational impact, and passenger inconvenience. For example, the MEL engine 114 may determine a safety score for the aircraft for each of the plurality of MEL resolution candidates. The MEL engine 114 may select the MEL resolution candidate from the plurality of MEL resolution candidates based on a safety score for the selected MEL resolution candidate exceeding a threshold. In one example, this threshold may be a risk level threshold provided by a preconfigured policy. By automating the decision-making process, the MEL engine 114 may minimize human error and may better ensure consistent application of MEL requirements. The MEL engine 114 may quickly analyze data and may generate proposed MEL resolutions 208, enabling faster response to AOG situations. The MEL engine 114 may consider a wider range of factors than humans might, leading to more optimized decisions that balance safety, cost, and operational efficiency. By analyzing historical data (e.g., MEL incidents 211) and identifying trends, the MEL engine 114 may help airlines proactively address potential MEL issues before they lead to AOG situations. By better ensuring accurate and timely application of MEL requirements, MEL engine 114 may help prevent incidents caused by operating aircraft with inoperative equipment. Optimized decisions may minimize AOG time, reduce the need for expensive emergency repairs, and minimize passenger compensation costs. In an aspect, MEL engine 114 may be integrated with a data analytics platform 214 in order to provide a centralized platform for accessing and managing aircraft data. The data analytics platform 214 may already have access to a lot of the data the MEL engine 114 would need (e.g., aircraft health data, maintenance records).

The sheer number of components in an aircraft, such as aircraft 100, may create a significant challenge for maintenance. Tracking the condition of each part, predicting potential failures, and managing repairs may be a complex undertaking. Maintaining airworthiness may be important. Any defect, even seemingly minor ones, may potentially compromise safety if not properly addressed. Traditional, manual methods of managing maintenance and MELs are often slow, error-prone, and struggle to keep pace with the volume of data generated by modern aircraft. Digital nature of data analytics platform 214 may provide the ideal foundation for automating the MEL process. The data analytics platform 214 may integrate data from various sources and may provide a centralized platform for managing maintenance information (e.g., maintenance logs 218). Data analytics platform 214 may also integrate with historical data on maintenance performed, parts replaced, and repairs conducted. Data analytics platform 214 may also be integrated with information that may impact maintenance decisions (e.g., if a repair needs to be done quickly due to impending severe weather). MEL resolution recommendation system 112 may potentially integrate with real-time data from the aircraft's sensors and systems (e.g., engine health monitoring, flight data recorders, etc.). MEL resolution recommendation system 112 may also include the official MEL document itself, ensuring compliance with regulations. MEL resolution recommendation system 112 may incorporate real-time information on the availability and location of spare parts. MEL resolution recommendation system 112 may further include data on upcoming flights to help prioritize maintenance and minimize disruptions. In an aspect, the disclosed techniques, by automating the MEL resolution process, may reduce the manual effort required by pilots, dispatchers, and operations personnel. The disclosed MEL resolution recommendation system 112 may provide real-time data and decision support tools to help the team make informed choices about how to handle MEL incidents 211. The disclosed system may minimize the risk of human error in interpreting MEL requirements or coordinating maintenance activities. The MEL resolution recommendation system 112 may help airlines schedule maintenance efficiently, minimizing aircraft downtime and maximizing aircraft utilization. Output modules 104 may provide a user-friendly interface for reporting defects and access MEL information 202 to pilots 204 in the cockpit. The disclosed MEL resolution recommendation system 112 may also help to monitor the status of aircraft 100 and may coordinate maintenance activities. The disclosed system may help maintenance personnel (maintainers 212) to manage maintenance schedules, spare parts inventory, and other resources. The efficiencies gained through automation may lead to significant cost savings for airlines, including, but not limited to, reduced maintenance costs, minimized AOG time, and lower passenger disruption expenses. Improved aircraft utilization may lead to increased revenue generation.

In an aspect, the MEL engine 114 may be configured to determine the best course of action when equipment fails. In the context of the present disclosure the term “best course” may be defined by a combination of factors. MEL engine 114 may be configured to minimize the financial impact of the failure, including repair costs, lost revenue from downtime, and passenger compensation. MEL engine 114 may be configured to reduce the amount of time aircraft 100 is out of service (AOG). In addition, the MEL engine 114 may ensure that any solution complies with safety regulations and minimizes risks to the aircraft and passengers of the aircraft. The connection of the MEL engine 114 to the aircraft's avionics system 102 may be important. This connection may allow MEL engine 114 to receive real-time data on the status of aircraft equipment. The MEL engine 114 may continuously monitor the avionics for equipment failures. This real-time monitoring may allow for immediate response to issues. When a failure is detected, MEL engine 114 may gather information from multiple sources to build a comprehensive picture of the situation. The MEL engine 114 may consult the official MEL document to determine if the aircraft 100 is permitted to fly with the failed equipment and under what conditions. MEL engine 114 may retrieve current maintenance logs 218 to see if there are any existing issues with the same or related equipment. This retrieval may help to avoid redundant work or conflicting solutions. In an aspect, MEL engine 114 may consider the following information based on the status of the entire fleet. Are other aircraft experiencing similar issues? Are there spare parts readily available on other aircraft that could be quickly transferred? Information on the availability of spare parts and maintainers 212, as well as the aircraft's upcoming flight schedule, may be factored into the decision-making process. Real-time access to spare parts inventory may be important for quickly identifying available parts and their location. Based on the gathered data, MEL engine 114 may generate different possible MEL resolution candidates (e.g. resolution scenarios) to the equipment failure. These scenarios may include, but are not limited to, the following. If the MEL procedures allow, the repair may be deferred until a later time, perhaps during scheduled maintenance. The MEL engine 114 may determine any operational restrictions associated with the deferral. If the failure requires immediate attention, the MEL engine 114 may identify the necessary parts, locate them, and schedule maintenance. The MEL engine 114 may identify approved alternate parts that may be used if the primary part is unavailable. In some examples, it might be faster to take a part from another aircraft in the fleet (if that aircraft's schedule allows).

In an aspect, each potential MEL resolution 208 generated by the MEL engine 114 may be “tested” within by a digital twin component 308. This digital twin 308 may be a component of MEL engine 114 and may be a virtual replica of aircraft 100, including systems, components, and performance characteristics of the aircraft 100. By simulating the impact of each scenario on the digital twin 308, the MEL engine 114 may accurately compute the financial implications of the scenario, including, but not limited to, parts costs, labor costs, potential flight delays or cancellations (and associated passenger costs), and any other relevant expenses. MEL engine 114 may also determine the estimated time required to implement the proposed MEL resolution 208, including but not limited to, repair time, parts procurement time, and any resulting downtime for aircraft 100. In addition, MEL engine 114 may determine the potential impact on safety margins, considering factors such as, but not limited to, redundancy, system performance degradation, and any operational restrictions imposed by the MEL details 220. The digital twin component 308 of MEL engine 114 may simulate how aircraft 100 would perform with the failed equipment under various conditions. In an aspect, MEL engine may allow airlines to define policies that reflect their priorities. For example, an airline may choose to prioritize cost reduction, minimizing AOG time, or maximizing safety. Based on the chosen policy, MEL engine 114 may rank the different resolution candidates. If the policy prioritizes cost, the scenario with the lowest cost may be ranked highest. If safety is the primary concern, the safest option (e.g., MEL resolution 208) may be preferred. The MEL resolution recommendation system 112 may automatically identify the “best” scenario based on the configured policy. This may ensure that the chosen MEL resolution 208 aligns with the specific objectives of the airline. The recommended MEL resolution 208, along with the supporting analysis from the digital twin 308, may be transmitted to avionics system 102. Avionics system 102 may render the recommended MEL resolutions 208 as MEL insights 202 to the crew (pilots) 204 and/or the dispatcher 210. While the MEL resolution recommendation system 112 may recommend the best option, it may be important to maintain human oversight. The crew 204 and dispatcher 210 may have the opportunity to review the recommendation of the MEL resolution 208, consider any other relevant factors not captured by the system, and either accept or reject the proposed MEL resolution 208. This may better ensure that human judgment remains part of the decision-making process. The use of digital twin 308 and policy-based optimization may better ensure that the MEL resolution recommendation system 112 decisions are based on objective data and analysis, rather than gut feeling or guesswork. MEL engine 114 may provide a much more accurate assessment of the cost, time, and safety impacts of different resolution scenarios compared to manual estimations. The automated evaluation process may significantly speed up the MEL resolution process, minimizing AOG time. The MEL resolution recommendation system 112 may be more likely to identify the truly best solution, considering all relevant factors and the airline's specific priorities.

FIG. 3 illustrates an example of MEL engine in accordance with the techniques of this disclosure. As noted above, the MEL document may outline the specific conditions under which an aircraft may be operated with certain equipment inoperative. The available MEL resolutions 302 (e.g., deferral, repair, replacement) may be defined within the MEL. These MEL resolutions 302 may be the foundation of any scenario. It should be noted that scenario management module 304 of MEL engine 114 cannot create a scenario that violates the MEL. The airline schedule 301 may be another important constraint. A proposed MEL resolution 302 that requires aircraft 100 to be grounded for an extended period may be unacceptable if aircraft 100 is scheduled for a critical flight. Conversely, a solution that allows the aircraft 100 to fly with a minor defect may be preferable if the flight is already delayed. The airline schedule 301 may help scenario management module 304 determine the urgency of the repair and the cost of downtime. Fleet data 303 may provide context and resources. Information about other aircraft in the fleet (their location, maintenance status, parts availability) may significantly impact the optimal solution. For example, if a needed part is available on another aircraft that is currently at a maintenance base, it may be faster and cheaper to transfer the part than to wait for a new part to be shipped. Knowing the location and availability of maintainers 212 may influence scheduling. In some cases, aircraft may be swapped to minimize disruption to the schedule. The MEL document may provide the starting point for any scenario. Scenario management module 304 may use the allowed MEL resolutions 302 for the specific equipment failure as the basis for generating possible resolution candidates (e.g., MEL recommendations 318). The airline schedule 301 may be used to evaluate the impact of each potential MEL resolution 302. Scenario management module 304 may determine the potential delay or cancellation costs associated with different repair timelines. Scenario management module 304 may also identify “maintenance windows” where repairs may be performed with minimal disruption to the airline schedule 301. Fleet data 303 may help optimize resource allocation. Scenario management module 304 may quickly identify the location of needed spare parts within the fleet. Scenario management module 304 may identify maintenance activities based on the availability of maintenance personnel and the location of aircraft 100. MEL engine 114 may propose MEL recommendations 318 that minimize disruption to the overall flight schedule by considering the location and status of all aircraft in the fleet. By combining these inputs (e.g., airline schedule 301, MEL resolutions 302 and fleet data 303), the scenario management module 304 may prioritize resolution scenarios based on a variety of factors, including, but not limited to, cost, time, safety, and schedule adherence. The “best” scenario may be the one that best balances these competing priorities. As a non-limiting example, an aircraft may experience a minor hydraulic system failure that is covered by the MEL. Scenario management module 304 may identify that the needed part is available at a nearby maintenance base, but the repair may take 4 hours, causing the cancellation of a scheduled flight. In a second scenario, the MEL may allow aircraft 100 to fly with the affected system for a limited time. Scenario management module 304 may determine that the repair may be deferred until the aircraft's next scheduled maintenance stop, which may be 2 days away. In a third scenario, scenario management module 304 may identify that another aircraft in the fleet, currently at a maintenance base, has the needed part. Swapping the part may take 2 hours and would not impact any scheduled flights.

In an aspect, flight mission information 306 may include details such as, but not limited to, the planned route, flight duration, altitude, weather conditions, and other mission-specific parameters. Knowing the flight mission 306 may allow the digital twin module 308 to simulate the performance of aircraft 100 with the MEL failure under realistic operating conditions. The aircraft state parameters 305 may include real-time data points from the aircraft's systems, including, but not limited to, engine performance, fuel consumption, hydraulic pressure, electrical system status, and many other sensor readings. These aircraft state parameters 305 may provide digital twin module 308 with the current “health” and operational status of the aircraft 100. Output 307 of the scenario management module 304 may be an important feedback loop. The output 307 of the scenario management module 304 may include the chosen MEL resolution 302 (e.g., deferral, repair, parts swap), the predicted impact on cost, time, and safety, and any operational restrictions. By incorporating real-world flight data (aircraft state parameters 305) and planned mission details included in flight mission 306, digital twin 308 may become much more accurate in predictions. The digital twin module 308 may learn how aircraft 100 actually performs under different conditions and may refine the corresponding models accordingly. The output 307 of the scenario management module 304 (the chosen MEL resolution 302 and its predicted impact) may be compared by digital twin module 308 to the actual outcome in the real world. This simulation may allow the MEL engine 114 to validate the accuracy of predictions and identify areas for improvement. For example, if digital twin module 308 predicted that a repair would take 2 hours, but the repair actually took 3 hours, the digital twin module 308 may analyze the discrepancy and may adjust future predictions. By continuously learning and refining various models, digital twin module 308 may provide even more accurate and reliable recommendations for future MEL events. The digital twin module 308 may also help identify trends and patterns that may not be apparent from manual analysis. The combination of flight mission information 306, aircraft state parameters 305, and output 307 of scenario management module 304 may be used to predict potential future failures. By analyzing trends and identifying early warning signs, digital twin module 308 may recommend proactive maintenance actions to prevent failures before they occur. This entire process may create a closed-loop feedback system. The results of real-world operations may be used to improve the digital twin module 308, which in turn may lead to better decision-making in the future. This continuous improvement cycle may be important for maximizing the benefits of digital twin technology.

In an aspect, flight database 316 may contain historical data on past flights, including, but not limited to, aircraft performance, maintenance records, pilot reports, and other relevant information. This historical data may be important for identifying trends and patterns that may not be apparent from real-time data alone. The policies and regulations input 317 may better ensure that all MEL recommendations 318 comply with relevant aviation regulations (e.g., FAA, European Union Aviation Safety Agency (EASA)) and the airline's own internal policies regarding safety, maintenance, and operations. These rules and constraints may be important for safe and legal operations. As discussed above, digital twin module 308 may provide detailed predictions about the impact of different MEL resolutions 302 on the aircraft's performance, cost, time, and safety. This information may be one of the key inputs for the inference engine 310. The cost evaluator module 312 may analyze the financial implications of different MEL resolutions 302. The cost evaluator module 312 may consider factors such as, but not limited to, parts costs, labor costs, potential revenue loss from delays or cancellations, and passenger compensation. The safety assessment module 314 may evaluate the safety risks associated with each MEL resolution 302. The safety assessment module 314 may consider factors such as, but not limited to, system redundancy, potential failure modes, and operational restrictions. The inference engine 310 may use the inputs described above to generate MEL recommendations 318. In an aspect, the inference engine 310 may process the data from the flight database 316, policies and regulations 317, and the output 309 of digital twin module 308. The inference engine 310 may employ a set of pre-defined rules and logic (which may incorporate machine learning) to evaluate the different MEL resolution 302 options. These rules may be designed to balance safety, cost, and operational efficiency while ensuring compliance with regulations and airline policies. Based on the analysis, the inference engine 310 may generate specific, actionable MEL recommendations 318. These MEL recommendations 318 may include deferring the repair (if allowed by the MEL) and specifying any operational restrictions. In another example, the MEL recommendation 318 may include identifying the optimal spare part and location of the spare part. In yet another example, the MEL recommendations 318 may include suggesting alternative maintenance procedures. In an example, the inference engine 310 may recommend a course of action to minimize passenger disruptions. The inference engine 310 may rank the MEL recommendations 318 based on factors, such as but not limited to, safety, cost, operational impact, and passenger inconvenience. The inference engine 310 may also indicate why the inference engine 310 made a particular MEL recommendation 318, providing transparency and justification for provided recommendations 318. The inference engine 310 may consider a wider range of factors than humans might, leading to more optimized decisions. The inference engine 310 may better ensure consistent application of MEL requirements and airline policies. By incorporating safety assessments into the aforementioned decision-making process, the inference engine 310 may help minimize risks. The cost evaluator module 312 may help identify the most cost-effective solutions.

FIG. 4 illustrates an example of an avionics system in accordance with the techniques of this disclosure. Avionics 102 is specialized computing hardware configured to store and execute avionics applications. In the example of FIG. 2, avionics 102 includes processing circuitry 410, memory 420 which stores avionics applications 422, communication interface(s) 440 to communicate with other devices, such as input device(s) 450, output device(s) 460, navigational database 470, and flight data recorder(s) 480. The aforementioned components of avionics 102 may be connected to one another through a bus 430, which generally represents one or more busses and is intended to generically represent all the electrical and data connectivity of internal components included within avionics 102.

Processing circuitry 410 implements the functionality of and/or executes the instructions associated with avionics applications 422. Processing circuitry 410 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics 102 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within avionics 102. In some implementations, memory 420 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 4 as avionics applications 422) may be stored in any volatile and/or non-volatile memory component of memory 420.

Communication interface(s) 440 generally represents all hardware e.g., transceiver circuitry, within avionics 102 for communicating with external devices either on the ground or while in flight. Communication interface(s) 440 may facilitate communication with external devices via one or more wired and/or wireless network connections by transmitting and/or receiving signals on the one or more networks. Examples of communication interface(s) 440 include a network interface card (e.g. such as an Ethernet card), an optical transceiver, a radio frequency transceiver, a GPS receiver, or any other type of device that can send and/or receive information. Other examples of communication interface(s) 440 may include short wave radios, cellular data radios, wireless network radios, as well as USB controllers. Examples of communication interface(s) 440 for in-flight communication include a very high frequency (VHF) radio, a high frequency (HF) radio, or a satellite communication (SATCOM) radio.

Examples of communication interface(s) 440 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 440 used for data links include controller-pilot data link communications (CPDLC) which allows air traffic control to send instructions and receive acknowledgments from pilots via text messages. Communications interface(s) 440 may also include an automatic dependent surveillance-broadcast transponder. The various examples of communications interfaces listed above represent a non-exhaustive list of the types of the types of communication interfaces that may be included in communication interface(s) 440.

Avionics 102 also includes input device(s) 450 and output device(s) 460. Examples of input device(s) 450 include control display units (CDUs) with alphanumeric keypads or touchscreens to enter flight plans, waypoints, and other necessary data. Input device(s) 450 may also include a Flight Management System (FMS) control panel for entering information to the FMS 402, such as route, altitude, and speed using dedicated buttons, knobs, and touchscreen interfaces. Input device(s) 450 may also include yoke or sidestick controls as well as touchscreen interfaces. Input device(s) 450 may also include rotary knobs for setting values for altitudes, speeds, and other parameters and toggle switches for selecting modes or turning systems on and off.

Examples of output device(s) 460 may include video/audio panels to relay MEL recommendations 318, communication from radios, and alerts from systems to the cockpit. Output device(s) 460 may also include an electronic flight instrument display to provide visual representations of flight data, including altitude, airspeed, heading, and attitude. Output device(s) 460 may also include a Heads-Up Display (HUD) that projects critical flight information onto a transparent screen in the pilot's line of sight or other cockpit displays to show navigation maps, engine parameters, system statuses, and the like. Output device(s) 460 may also include engine instrumentation displays to display data on engine performance, such as temperature, pressure, and revolutions per minute (RPMs). Output device(s) 460 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of input and output devices that may be included in input device(s) 450 and output device(s) 460. Additionally, input and output functionality of avionics 102 may be facilitated by external devices that are separate from input device(s) 450 and output device(s) 460.

Avionics applications 422 represent a suite of software tools that may be used by a pilot in managing flight operations and managing the aircraft while in flight. Avionics applications 422 includes FMS 402 discussed above as well as other applications for communication, navigation, and monitoring within aircraft 100. Avionics applications 422, for example, may include applications for processing and displaying weather radar data and presenting essential flight information such as altitude, airspeed, attitude, and heading to a pilot. Avionics applications 422 may also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 422 may also include the software to manage various emergency systems (e.g., an emergency locator transmitter, flight data recorder 480, and cockpit voice recorder) and cabin management systems (e.g., passenger infotainment systems and environmental control systems).

Navigational database 470 represents a specialized database that stores information needed by FMS 402 for the navigation and operation of an aircraft for purposes such as flight planning, route management, and ensuring safe navigation throughout a flight. Navigational database 470 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. Flight data 472 may be data regarding planned routes, altitudes, and waypoints for a specific flight. The locations of waypoints, airports, and navigational aids may, for example, be defined by geographical coordinates.

Navigational database 470 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 470 may be regularly updated to reflect changes in air traffic regulations, airport information, and navigational aids to ensure pilots have current information for safe and efficient flight operations.

Although not explicitly shown in FIG. 4, avionics 102 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 102 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 480 may be configured to record, and store in memory 420, flight data 472. In some examples, flight data recorder(s) 480 may have dedicated memory, meaning the memory that stores flight data 472 is separate than, for example, the memory that stores avionics applications 422. Flight data recorder(s) 480 may include any combination of one or more flight data recorders including a quick access recorder, a deployable recorder, or a combined cockpit voice recorder and flight data recorder.

Flight data recorder(s) 480 may be configured to record flight dynamics and motion data. For example, flight data recorder(s) 480 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 480 may also be configured to record control surfaces and positioning data. For example, flight data recorder(s) 480 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 480 may also be configured to record engine parameters. For example, flight data recorder(s) 480 may be configured to record the aircraft's engine output (e.g., engine thrust or power level), the aircraft engine's core and fan shaft speeds (i.e., N1and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 480 may also be configured to record environmental conditions data. For example, flight data recorder(s) 480 may be configured to record outside air temperature, the presence of ice on wings or other critical surfaces, storm and weather information, and wind speed and direction.

Flight data recorder(s) 480 may also be configured to record aircraft systems and equipment data. For example, flight data recorder(s) 480 may be configured to record autopilot status, such as whether autopilot is engaged and what mode (altitude hold, heading mode, etc.) is being implemented. Flight data recorder(s) 480 may also be configured to record the position of the landing gear (e.g., up, down, or transit), brake pressure or braking force applied during landing, hydraulic pressure of braking systems, and cabin altitude and pressurization levels. Flight data recorder(s) 480 may also be configured to record electrical systems status, such as voltage, current, and operational state of systems.

Flight data recorder(s) 480 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 480 may also be configured to record crew inputs. For example, flight data recorder(s) 480 may be configured to record control inputs, such as a pilot's inputs on yoke/stick, rudder pedals, and throttle. Flight data recorder(s) 480 may also be configured to record status or positions of switches (e.g., fuel pumps, anti-ice). Flight data recorder(s) 480 may also be configured to record communication controls, such as transponder codes, frequency changes, and communications status.

Flight data recorder(s) 480 may also be configured to record the status of warning and alarm systems, such as the status of alarms such as stall warnings, overspeed warnings, or terrain awareness warnings. Flight data recorder(s) 480 may also be configured to record engine and system alerts, such as malfunction notifications related to engine failures, low hydraulic pressures, or other such warnings. Flight data recorder(s) 480 may also be configured to record crew announcements and chimes. Flight data recorder(s) 480 may also be configured to record aural feedback notifications/announcements, in response to crew inputs, as described herein.

In one example, processing circuitry 410 may execute FMS 402. In some examples FMS 402 may calculate takeoff and landing performance. In some examples, FMS 402 may monitor fuel consumption and may alert pilots to potential fuel shortages. In some examples. FMS 402 may interface with the autopilot to control aircraft flight. In some examples, FMS 402 may automatically adjust flight parameters based on changing conditions.

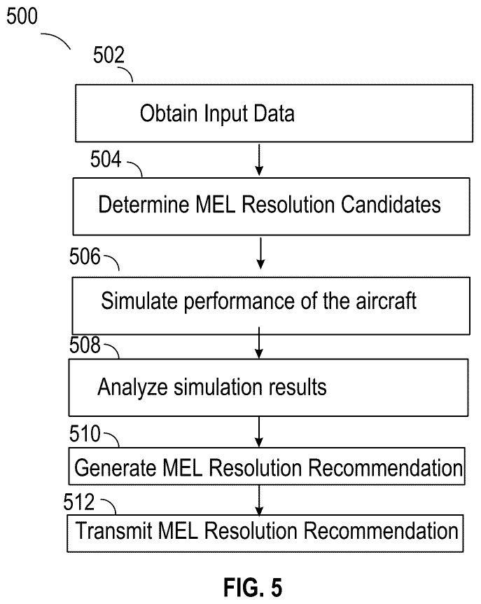

FIG. 5 depicts a flowchart illustrating a method for generating MEL resolution recommendation in accordance with the techniques of the present disclosure.

Process 500 will be described with respect to MEL resolution recommendation system 112, but it should be understood that other computing systems may also be configured to perform process 500. MEL resolution recommendation system 112 may obtain input data (502). The input data includes at least MEL failure information and a plurality of possible MEL resolutions. Users may input a specific MEL failure item (e.g., “Inoperative #2 hydraulic pump”) via interface 110, for example. Next, scenario management module 304 may determine, using the input data, one or more MEL resolution candidates (504). For example, scenario management module 304 may quickly identify the location of needed spare parts within the fleet. As another non-limiting example, scenario management module 304 may identify maintenance activities based on the availability of maintenance personnel and the location of aircraft 100.

In accordance with the techniques of the present disclosure, digital twin module 308 may simulate performance of aircraft 100 with the MEL failure for the plurality of MEL resolution candidates to generate simulation results for the aircraft 100 (506). In one example, knowing the flight mission 306 may allow the digital twin module 308 to simulate the performance of aircraft 100 under realistic operating conditions. In an aspect, digital twin module 308 may allow airlines to simulate the impact of MEL resolution candidates before the candidates are implemented in the real world.

In an aspect, inference engine 310 may analyze the simulation results, using a predefined policy, to select an MEL resolution candidate from the plurality of MEL resolution candidates. (508). Based on the analysis, the inference engine 310 may generate specific, actionable indication of the MEL resolution recommendations 318 (510). In an example, the inference engine 310 may recommend a course of action to minimize passenger disruptions. In an aspect, MEL resolution recommendation system 112 may transmit the indication of the MEL resolution recommendation to the computing system of the aircraft (512). In one example, inference engine 310 may transmit the indication of the MEL resolution recommendation to the avionics system 102. Avionics system 102 may provide a user-friendly interface for reporting defects and access MEL information 202 to pilots 204 in the cockpit.

The general discussion of the present disclosure provides a brief, general description of a suitable computing environment in which the present disclosure may be implemented. Any of the disclosed systems, processes, and/or graphical user interfaces may be executed by or implemented by a computing system consistent with or similar to that depicted and/or explained in the present disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

One or more includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, but these elements should not be limited by these terms. Except where otherwise indicated, these terms are only used to distinguish one element from another. For example, a first contact could be termed a second contact, and, similarly, a second contact could be termed a first contact, without departing from the scope of the various described examples. The first contact and the second contact are both contacts but may not be the same contact.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In the present disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout the present disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

Various examples have been described. These and other examples are within the scope of the following claims.

What is claimed is:

1. A computer-implemented method for generating a Minimum Equipment List (MEL) resolution recommendation, the method comprising:
obtaining input data from a computing system of an aircraft, wherein the input data includes at least MEL failure information identifying an MEL failure for the aircraft;
determining a plurality of MEL resolution candidates;
simulating performance of the aircraft with the MEL failure for the plurality of MEL resolution candidates to generate simulation results for the aircraft;
analyzing the simulation results, using a predefined policy, to select an MEL resolution candidate from the plurality of MEL resolution candidates;
generating an indication of an MEL resolution recommendation based on the selected MEL resolution candidate; and
transmitting the indication of the MEL resolution recommendation to the computing system of the aircraft.

2. The method of claim 1, wherein the MEL resolution recommendation includes at least one of: a recommendation to replace faulty equipment with a functional spare part, a recommendation to replace the faulty equipment with the functional equipment removed from a different aircraft, or a recommendation for the aircraft to fly with the faulty equipment.

3. The method of claim 1, wherein analyzing the simulation results comprises estimating costs of the plurality of MEL resolution candidates.

4. The method of claim 1, wherein analyzing the simulation results comprises:
determining a safety score for the aircraft for each of the plurality of MEL resolution candidates; and
selecting the MEL resolution candidate from the plurality of MEL resolution candidates based on a safety score for the selected MEL resolution candidate exceeding a threshold.

5. The method of claim 1, wherein obtaining input data further comprises selecting the plurality of MEL resolution candidates from a Master Minimum Equipment List (MMEL).

6. The method of claim 1, wherein transmitting the indication of the MEL resolution recommendation to the computing system of the aircraft comprises transmitting the indication of the MEL resolution recommendation to avionics of the aircraft.

7. The method of claim 1, wherein the predefined policy specifies at least a risk level threshold.

8. The method of claim 1, wherein:
the input data includes one or more aircraft state parameters;
the one or more aircraft state parameters indicate an operational status of the aircraft; and
simulating performance of the aircraft with the MEL failure for the plurality of MEL resolution candidates comprises generating the simulation results for the aircraft based on the aircraft state parameters.

9. A system for generating a Minimum Equipment List (MEL) resolution recommendation, the system comprising:
a memory; and
processing circuitry coupled to the memory and configured to:
obtain input data from a computing system of an aircraft, wherein the input data includes at least MEL failure information identifying an MEL failure for the aircraft;
determine a plurality of MEL resolution candidates;
simulate performance of the aircraft with the MEL failure for the plurality of MEL resolution candidates to generate simulation results for the aircraft;
analyze the simulation results, using a predefined policy, to select an MEL resolution candidate from the plurality of MEL resolution candidates;
generate an indication of an MEL resolution recommendation based on the selected MEL resolution candidate; and
transmit the indication of the MEL resolution recommendation to the computing system of the aircraft.

10. The system of claim 9, wherein the MEL resolution recommendation includes at least one of: a recommendation to replace faulty equipment with a functional spare part, a recommendation to replace the faulty equipment with the functional equipment removed from a different aircraft, or a recommendation for the aircraft to fly with the faulty equipment.

11. The system of claim 9, wherein the processing circuitry configured to analyze the simulation results is further configured to estimate costs of the plurality of MEL resolution candidates.

12. The system of claim 9, wherein the processing circuitry configured to analyze the simulation results is further configured to:
determine a safety score for the aircraft for each of the plurality of MEL resolution candidates; and
select the MEL resolution candidate from the plurality of MEL resolution candidates based on the safety score for the selected MEL resolution candidate exceeding a threshold.

13. The system of claim 9, wherein the processing circuitry is further configured to select the plurality of MEL resolution candidates from a Master Minimum Equipment List (MMEL).

14. The system of claim 9, wherein the processing circuitry configured to transmit the indication of the MEL resolution recommendation to the computing system of the aircraft is further configured to transmit the indication of the MEL resolution recommendation to avionics of the aircraft.

15. The system of claim 9, wherein the predefined policy specifies at least a risk level threshold.

16. The system of claim 9, wherein:
the input data includes one or more aircraft state parameters;
the one or more aircraft state parameters indicate an operational status of the aircraft; and
the processing circuitry configured to simulate performance of the aircraft with the MEL failure for the plurality of MEL resolution candidates is further configured to generate the simulation results for the aircraft based on the aircraft state parameters.

17. Non-transitory computer-readable storage media having instructions encoded thereon, the instructions configured to cause processing circuitry to:
obtain input data from a computing system of an aircraft, wherein the input data includes at least MEL failure information identifying an MEL failure for the aircraft;
determine a plurality of MEL resolution candidates;
simulate performance of the aircraft with the MEL failure for the plurality of MEL resolution candidates to generate simulation results for the aircraft;
analyze the simulation results, using a predefined policy, to select an MEL resolution candidate from the plurality of MEL resolution candidates;
generate an indication of an MEL resolution recommendation based on the selected MEL resolution candidate; and
transmit the indication of the MEL resolution recommendation to the computing system of the aircraft.

18. The storage media of claim 17, wherein the MEL resolution recommendation includes at least one of: a recommendation to replace faulty equipment with a functional spare part, a recommendation to replace the faulty equipment with the functional equipment removed from a different aircraft, or a recommendation for the aircraft to fly with the faulty equipment.

19. The storage media of claim 17, wherein the instructions configured to cause the processing circuitry to analyze the simulation results are further configured to cause the processing circuitry to estimate costs of the plurality of MEL resolution candidates.

20. The storage media of claim 17, wherein the instructions configured to cause the processing circuitry to analyze the simulation results are further configured to cause the processing circuitry to:
determine a safety score for the aircraft for each of the plurality of MEL resolution candidates; and
select the MEL resolution candidate from the plurality of MEL resolution candidates based on the safety score for the selected MEL resolution candidate exceeding a threshold.
